(19) United States
(12) Patent Application Publication
(10) Pub. No.: US 2025/0321571 A1
(43) Pub. Date: Oct. 16, 2025

(54) MULTI-MODEL FUSED AVIONIC PRODUCT HEALTH ASSESSMENT METHOD

(71) Applicant: THE 10TH RESEARCH INSTITUTE OF CHINA ELECTRONICS TECHNOLOGY GROUP CORPORATION, Chengdu, Sichuan (CN)

(72) Inventors: Jia WEN, Chengdu, Sichuan (CN); Xiaohu ZHAO, Chengdu, Sichuan (CN); Dejin YAN, Chengdu, Sichuan (CN); Dong QIAN, Chengdu, Sichuan (CN); Tianchen LIANG, Chengdu, Sichuan (CN); Banglan ZHOU, Chengdu, Sichuan (CN)

(21) Appl. No.: 18/867,315

(22) PCT Filed: May 25, 2023
(86) PCT No.: PCT/CN2023/096340

§ 371 Date: Nov. 19, 2024

(30) Foreign Application Priority Data
May 25, 2022 (CN) 202210572890.8
Aug. 2, 2022 (CN) 202210922051.4

(51) Int. Cl. G05B 23/02; B64D 45/00

(52) U.S. Cl. CPC G05B 23/0254; B64D 2045/0085

(57) ABSTRACT

A multi-model fused avionic product health assessment method includes the following steps: collecting relevant data of an avionic product; performing data pre-processing on the relevant data to obtain first data and second data; training a plurality of base models on the basis of the first data; performing quantitative measurement and fusion on the plurality of base models to obtain an integrated model; and inputting into the integrated model the second data which serves as a test sample to obtain a health assessment result of the avionic product. A plurality of base models are integrated by using an AdaBoost algorithm, and a reference can be provided for a method based on data driving in terms of application in the health assessment, prediction and management of an avionic product.

### CROSS-REFERENCE TO RELATED APPLICATIONS

This application claims priority to China Patent Application No. 202210922051.4 titled “Avionic Product Health Assessment Method Based on Multi-model Fusion” filed to China National Intellectual Property Administration on Aug. 2, 2022 and China Patent Application No. 202210572890.8 titled “Airborne Health Management Domain Design Method Based on Multi-level Model Fusion” filed to China National Intellectual Property Administration on May 25, 2022, the contents of which are incorporated herein by reference in their entirety.

### TECHNICAL FIELD

The present invention relates to the technical field of health assessment, in particular to a multi-model fused avionic product health assessment method, which is used for the development of intelligent diagnosis system software of modern highly integrated modular avionic products and provides technical support for on-condition maintenance of the system.

### BACKGROUND

With the rapid development of modern electronic information technology and the wide application of large-scale integrated circuits and chips, the avionic system plays an increasingly important role in the aircraft platform with more complex system functions and larger hardware scale. Hence, the fault of a single product has greater potential impact on the flight safety and mission reliability. On the one hand, the highly integrated design of avionic system provides higher complexity for digital-RF signal crosslinking inside the system. The types of digital buses have been expanded from the original single 1553B bus to RapidIO, CAN bus, 100 M/1 Gbit/10 Gbit Ethernet and the like, and the types and frequency bands of RF signals have more than doubled. System mode handoff and functional reconfiguration lead to the complex routing handoff between digital and RF signals, which increases the uncertainty of fault propagation and superimposes the features of randomness and intermittence of the avionic product faults, highlighting the difficulty in the fault identification and health assessment of the system. On the other hand, the aircraft health management domain is structurally divided according to state monitoring, fault diagnosis, trend analysis, fault prediction, display/record, maintenance manual, etc., while the highly-integrated airborne system is subject to the R&D mode of multi-module integration. In this case, the functions of one health management domain may be mapped to a plurality of different module contractors, the many-to-many relationship exists between functions and contractors, and the difficulty in the division and process coordination of contractor working interfaces is raised. Additionally, there is a lack of a universal definition of diagnosis model structure for the model design at different levels, and the diagnostic models developed by contractors with different levels of competence vary in quality.

Health assessment and prediction means that various algorithms (Fourier transform, Kalman filtering, etc.) and intelligent models (physical model, neural network, expert system, etc.) are employed to monitor, assess, and predict the health state of products by using advanced sensors to collect all kinds of data and information of equipment, which can effectively solve the problems, such as a limited capability for BIT-based fault detection and isolation of the modern highly-integrated avionics system and a lack of precise and quantitative fault and degradation assessment and prediction means and is a key technology to realize fault reconstruction and on-condition maintenance of the avionics system. At present, the health assessment and prediction methods are primarily divided into fault model-based and data-driven methods. The prediction method based on the physics-of-failure (PoF) model is leveraged to recognize the failure mechanism of a product and the accurate parameters of product degradation through conducting PoF experiments or simulations and build a PoF model of the product on this basis to meet the needs of fault assessment and prediction. Although this method has shown results in laboratory validation, its application to avionic products raises the following problems: (1) building a PoF model requires an adequate and in-depth understanding of the fault mechanism of a product, and the modeling process is often independent and personalized and is difficult to inherit. No particularly good universal model for avionic products has been released yet, and customized PoF models are difficult to widely use in practical engineering due to their high costs. (2) The running process of avionic products is affected by multiple factors, such as hot and humid conditions, vibration, and complex electromagnetic environment (EME), the fault mechanism is complicated, the boundary of PoF model building is difficult to determine, and the accuracy of prediction results is poor in engineering practice.

The data-driven health assessment method has the advantage of not requiring in-depth research into the fault mechanism or building an accurate failure model. Especially for complex systems like aerospace systems, the PoF model characterizing the performance degradation and remaining useful life of electronic products is difficult to build, while these products have a huge number of available state monitoring information and testing data, so the data-driven method has received a lot of attention from the National Aeronautics and Space Administration (NASA) and many research institutions and enterprises.

At present, the data-driven method includes support vector machine (SVM), long short-term memory (LSTM) neural network model, deep belief network (DBN) model, unscented particle filter, stochastic process model, etc. These methods mainly face two technical problems in their application to complicated avionic products: 1) due to the adoption of multi-level architecture by the avionics system, models at different levels, such as module level, function level, and subsystem level, are confronted by the differences in complex electromagnetic, mechanical, and environmental stresses of different aircraft platforms and the model differences caused by using mode differences; 2) the avionic products of the same aircraft platform face model differences caused by differentiated operating environments in different areas, such as freezing and extremely cold environments in plateaus, desert environments with an enormous diurnal temperature variation, high humidity and salt-spray environments on oceanic islands and reefs. A single model can hardly meet the requirements if it faces complex multi-level and multi-scenario application conditions, so it is necessary to propose a multi-model fused avionic product health assessment method to improve algorithm stability and accuracy of diagnostic prediction.

### SUMMARY

To solve insufficient generalization, poor assessment accuracy, and other problems confronting the existing health assessment methods to avionic products in harsh environmental conditions of multi-region deployment and complex working conditions of multiple platforms, the present invention provides a multi-model fused avionic product health assessment method, characterized by high stability and generalization, adaptation to scenarios with large differences, high degree of fitting of trend, high accuracy, and meeting the needs for on-condition maintenance. The present invention discloses a multi-model fused avionic product health assessment method, comprising:
collecting relevant data of an avionic product;
performing data pre-processing on the relevant data, wherein the pre-processed data comprise first data and second data;
training a plurality of base models on the basis of the first data;
performing quantitative measurement and fusion on the plurality of base models, so as to obtain an integrated model; and
inputting into the integrated model the second data which serves as a test sample, so as to obtain a health assessment result of the avionic product

In an embodiment, the relevant data are a parameter representing health state of the avionic product; the parameter includes at least one of the following: a working voltage value, a current value, a temperature value, loading state, a clock lock mark and a signal amplitude of the avionic product; the data pre-processing comprises at least one of the following: a statistical value of the data statistics includes at least one of the following: an average, a median and a frequent value; and a method for the data optimization includes at least one of the following: singular value elimination, missing value filling, data smoothing and data dimension reduction.

In an embodiment, the plurality of base models at least comprises a machine learning model, an unscented particle filter model and a stochastic process model; wherein, the machine learning model includes at least one of the following: a support vector machine, a long short-term memory neural network and a deep belief network.

In an embodiment, a training rule of the support vector machine comprises: training set composition: composed of training data and labels, a training data is [m, 1], denoting classification label values corresponding to m samples; a training sample size accounting for 70% of a total sample size; testing set composition: having a data structure consistent with the training set and a test sample size accounting for 30% of the total sample size; and a model hyperparameter includes at least one of the following: kernel selection, penalty term, and kernel coefficient for kernel function.

In an embodiment, a training rule of the deep belief network comprises: a training set: composed of training samples and prediction labels, wherein a feature number of the training samples depends on a number of channels for collecting data and a sample size required for each channel; a training data matrix is [m, n] and a label matrix is [m, 1], denoting prediction label values of m samples; a training sample size accounts for 70% of a total sample size; a testing set: having a testing data matrix of [o, 1], denoting o data besides the training sample; and a test sample size accounts for 30% of the total sample size; a model structure parameter includes at least one of the following: a number of layers, an attribute of each layer and a number of neurons of each layer; and a model hyperparameter includes at least one of the following: a number of epochs, a batch size for training, a learning rate and an activation function.

In an embodiment, a training on the unscented particle filter model and the stochastic process model is to determine a prediction model and a prior distribution from historical data, and continuously update a weight according to the samples to obtain a posterior distribution of states, thereby completing the updating of the prediction model.

In an embodiment, the step of training a plurality of base models on the basis of the first data comprises: completing a model structure initialization according to the model structure parameter and the model hyperparameter in the training rule;
using the first data as the training sample and performing a feedforward operation on the models to obtain an output value for the models corresponding to the training sample;
performing backpropagating refinement of an error in the label and the output value of the training sample based on the gradient descent algorithm and updating the internal weight and bias of the models; and
iteratively inputting the training sample until the error converges to or reaches the maximum iterations.

In an embodiment, the quantitative measurement is divided into two categories, namely, a health assessment and a trend prediction; wherein, the quantitative measurement parameter of the health assessment includes at least one of the following: an accuracy rate and a precision rate; wherein, the accuracy rate indicates a ratio of all correct classification results to all classification results; and the precision rate indicates a ratio of data correctly judged as one class to all data judged as the class; the quantitative measurement parameter of the trend prediction adopts at least one of the following: a root-mean-square error, a mean absolute error and a correlation coefficient; wherein, the root-mean-square error is a square root of a ratio of a sum of squared error between an observed value and a true value to a number of observations; the mean absolute error is an average of an absolute value of an error between the observe value and the true value; and a calculation formula of the correlation coefficient is shown as follows:

$$r ( X , Y ) = \frac{Cov ( X , Y )}{\sqrt{Var \vert X \vert Var \vert Y \vert}} \qquad ( 1 )$$

where X is the observed value, Y is the true value, Cov(X,Y) is the covariance between X and Y, Var|X| is the variance of X, and Var|Y| is the variance of Y.

In an embodiment, in the process of performing quantitative measurement and fusion on the plurality of base models, so as to obtain an integrated model comprises:
adopting the Adaboosting algorithm to optimize the combined strategy and adopting a linear error function to iterate over each base model to get a weight coefficient for a set of weak models;
when assembling a sample set of

$$D = {\{ {x}_{i} , {y}_{i} \}}_{i = 1}^{N} ,$$

the number of base models is T; where xᵢ is the training data of the i-th sample, yᵢ is the label of the i-th sample, and N is the number of training samples.

In an embodiment, a process of obtaining an integrated model comprises:
an initialization: initializing an error weight W₁ of an ensemble sample set of a target scene with an initialization formula shown as follows:

$${W}_{1} = ( {w}_{1 , 1} , {w}_{1 , 2} … {w}_{1 , N} ) , {w}_{1 , i} = \frac{1}{N} \qquad ( 2 )$$

where W_{1,i}, is an error weight of the i-th sample impacting the final error and W_{1,N} is an error weight of the N-th sample impacting the final error;
calculating the errors of the base models, and sequentially calculating the output ht of the base models, the maximum error Et of the sample, the relative error eti of the i-th sample and the prediction error rate et of the base learner according to the following linear loss function formula;

$${E}_{t} = max \vert {y}_{i} - {h}_{t} ( {x}_{i} ) \vert , i = 1 , 2 … N \qquad ( 3 )$$

$${e}_{ti} = \frac{\vert {y}_{i} - {h}_{t} ( {x}_{i} ) \vert}{{E}_{t}} \qquad ( 4 )$$

$${ε}_{t} = {\sum }_{1}^{N} {w}_{t , i} {e}_{ti} \qquad ( 5 )$$

where hₜ(xᵢ) is a calculated result of the t-th base model with the i-th sample and W_{t,i} is an influence weight of the i-th sample in the t-th base model that impacts the final error;
calculating the weight coefficient αₜ of the base models with a calculation formula shown as follows:

$${α}_{t} = \frac{{ε}_{t}}{1 - {ε}_{t}} \qquad ( 6 )$$

updating the error weight of the sample set, and sequentially calculating a generalization factor Zₜ, a new error weight of the sample W_{t+1,i} and a new error weight of the sample set Wₜ₊₁, with the following calculation formula:

$${Z}_{t} = {\sum }_{i = 1}^{N} {w}_{t , i} {α}_{t}^{1 - {e}_{ti}} \qquad ( 7 )$$

$${w}_{t + 1 , i} = \frac{{w}_{t , i}}{{Z}_{t}} {α}_{t}^{1 - {e}_{ti}} \qquad ( 8 )$$

$${W}_{t + 1} = ( {w}_{t + 1 , 1} , {w}_{t + 1 , 2} … {w}_{t + 1 , N} ) \qquad ( 9 )$$

where W_{i+1,N} is a new error weight of the N-th sample;
repeating Steps 42 to 44 until the prediction error rate is 0 or the number of base models reaches T; calculating an ensemble output of the base models with a calculation formula shown as follows:

$$H ( x ) = {\sum }_{t = 1}^{T} ( ln \frac{1}{{α}_{t}} ) K \qquad ( 10 )$$

where K denotes a median of all base model outputs.

In an embodiment, the step of collecting relevant data of an avionic product comprises: setting a data processing and distribution layer on a data acquisition and preprocessing layer, wherein, the data processing and distribution layer, the data acquisition and preprocessing layer, a data transmission layer and a display control and storage layer together form an aircraft comprehensive state monitoring and diagnosis system, and the data processing and distribution layer is the airborne health management domain; and the data acquisition and preprocessing layer collects, preprocesses and encapsulates state monitoring data of the airborne system to form a state monitoring data packet, and uploads the state monitoring data packet to the airborne health management domain through the data transmission layer. In an embodiment, the method further comprises: classifying the state of the airborne health management domain into four types: power-on BIT state, periodic BIT state, maintenance BIT state and fault state; if the power-on initialization is succeeded, switching from the power-on BIT state to the periodic BIT state; if the power-on initialization failed, switching from the power-on BIT state to the fault state; in the periodic BIT state, if a fatal fault occurs, switching to the fault state, and if a maintenance BIT command is received, enter the maintenance BIT state; in the fault state, if a maintenance BIT command is received, enabling the maintenance BIT state; in the maintenance BIT state, if maintenance BIT failed, switching to the fault state, and if an exit-maintenance-mode command is received, switching to the periodic BIT state.

In an embodiment, the method further comprises: dividing an external interface message of the airborne health management domain into an interface message between the data acquisition and preprocessing layer and the airborne health management domain and an interface message between the airborne health management domain and the display control and storage layer.

In an embodiment, the method further comprises: dividing the airborne health management domain into four levels: a module level, a functional thread level, a subsystem level and a system level, and setting tasks, input information, and output information at each level.

In an embodiment, the tasks at the module level are collaborative management and control of tests among multi-channel circuit units in a module, a fault-time stress analysis and a module health assessment; the input at the model level comprises at least one of the following: a modular model update command and a module power-on BIT command; the output at the model level comprises at least one of the following: monitoring parameters of working and environmental stresses, module health assessment and diagnosis results; the tasks at the functional thread level are collaborative management and control of multi-module tests, a fault collaborative analysis between modules and a functional health state assessment; the input at the functional thread level comprises at least one of the following: the module monitoring parameters of working and environmental stresses as well as the module health assessment and diagnosis results of the output at the module level and a functional thread model update command and a function power-on BIT command of the input at the subsystem level; the output at the functional thread level comprises at least one of the following: a functional thread state monitoring parameter and functional health assessment and diagnosis results; the tasks at the subsystem level are collaborative management and control of multi-threaded tests, a multi-thread fault correlation analysis and a subsystem residual capacity assessment; the input at the subsystem level comprises at least one of the following: the functional thread state monitoring parameter as well as the functional health assessment and diagnosis results of the output at the functional thread level and a subsystem model update command and a subsystem power-on BIT command of the input at the system level; the output at the subsystem level comprises at least one of the following: a subsystem state monitoring parameter, a software fault report and subsystem health assessment and diagnosis results; the tasks at the subsystem level are collorative management and control of tests among subsystems, cross-subsystem fault diagnosis and a system residual capacity assessment; the input at the system level comprises at least one of the following: the subsystem state monitoring parameter, the software fault report and the subsystem health assessment and diagnosis results of the output at the subsystem level; and the output at the system level comprises at least one of the following: system health state summary and system health state details.

In an embodiment, the method further comprises the following sub-steps: modeling the health assessment and diagnosis of the airborne health management domain based on a data management unit, a diagnosis model, a health assessment unit, an enhanced diagnosis unit, a fault prediction unit and a diagnosis process management unit that are constructed.

In an embodiment, the data management unit responds to key information, updates local cache, maps external input information to a diagnosis model, and completes the conversion between the external input data and the diagnosis model; the key information includes a fault report, a test data packet, a configuration message, a consumable and a state parameter that are output externally; the diagnosis model manages priori knowledge related to system diagnosis state; the health assessment unit performs abnormal detection of the functional thread and the module as well as the system-level residual capacity assessment; the enhanced diagnosis unit adopts a universal diagnosis inference engine which is relatively independent from the diagnosis model to perform fault tracing, fault validation, and fault correlation analysis; the fault prediction unit leverages a prediction method based on the feature trend, and performs data acquisition, parameter degradation trend tracking, and prediction feature extraction for a product or a component with an obvious degradation feature and a traceable fault rule; the diagnosis process management unit performs collaborative management of a model input data sets as well as health assessment, an enhanced diagnosis and a fault prediction process, transmits fault or return state of the functional thread and model output by the health assessment unit to the enhanced diagnosis unit or the fault prediction unit, eliminates a correlative fault, matches a degradation mode, and predicts the occurrence time of a fault; the diagnosis process management unit feeds the output results of the enhanced diagnosis unit and the fault prediction unit back to the health assessment unit again, thus providing input for the airborne system residual capacity assessment.

In an embodiment, the method further comprises: dividing a database table of the airborne health management domain into a system table, a cross-subsystem diagnosis result table, a subsystem table, a software fault report table, a network node state table, a function table, a function BIT result table, a function operation parameter table, a module table, a module BIT result table, a module working parameter table and a static BIT configuration table; the system table comprises at least one of the following: a system identifier, a cross-subsystem diagnosis result, and subsystem health state summary; the cross-subsystem diagnosis result table comprises at least one of the following: a diagnosis result identifier, a diagnosis time, a fault isolation result, and functional assessment result information; the subsystem table comprises at least one of the following: a subsystem identifier, subsystem health state details, a function identifiers it belongs to, a software fault report, and network node state information; the software fault report table comprises at least one of the following: a software identifier, a fault time, a fault type, a class identifier and a processor node identifier; the network node state table comprises at least one of the following: a network identifier, an acquisition time, a number of nodes, a node identifier, and node state; the function table comprises at least one of the following: a function identifier, a functional health state, a module identifier it belongs to, a function BIT result, and function operation parameter information; the function BIT result table comprises at least one of the following: a function identifier, an acquisition time, a number of test points, a test point identifier or ID, and test point state; the function operation parameter table comprises at least one of the following: a function identifier, an acquisition time, a number of parameters, a parameter identifier or ID and a parameter value; the module table comprises at least one of the following: a module identifier, module health state, a module BIT result and a module working parameter; the module BIT result table comprises at least one of the following: a module identifier, an acquisition time, a number of test points, a test point identifier, and test point state; the module working parameter table comprises at least one of the following: a module identifier, an acquisition time, a parameter identifier and a parameter value; the static BIT configuration table comprises at least one of the following: a number of test points, a test point identifier, a filter type, a threshold value and a test parameter type.

In an embodiment, the method further comprises: the system table is associated with the cross-subsystem diagnosis result table through the diagnosis result identifier, and with the subsystem table through the subsystem identifier it belongs to; the subsystem table is associated with the software fault report table through the software identifier, with the network node state table through the network identifier, and with the function table through the function identifier it belongs to; the function table is associated with the function BIT result table and the function operation parameter table through the function identifier, and with the module table through the module identifier it belongs to; and the module table is associated with the module BIT result table and the module working parameter table through the module identifier, and with the static BIT configuration table through the test point identifier.

With the technical solution above adopted, the present invention has the following advantages:

(1) The avionic product health assessment method based on multi-model fused designed by the present invention adopts the Adaboosting algorithm to integrate a plurality of base models, thereby improving the stability and precision of prediction and effectively solving the over-fitting problem of model training under a small sample condition of several full life cycles is effectively solved.

(2) Combined with the requirements for intelligent scheduling management and autonomous maintenance guarantee of the modern avionics system, a complete prediction model framework of the Adaboosting algorithm based on the multi-model fusion for the service life prediction problem confronting avionic product is proposed in this paper to solve the temporal information memory problem of fault prediction and the over-fitting problem of models under the small-sample condition. Simulation experiments show that, compared with the existing shallow learning model and classic LSTM model, the method presented in this paper has better stability, the trend fitting degree and the prediction precision, and a reference can be provided for a method based on data driving in terms of application in the health assessment, prediction and management of an avionic product.

(3) The method of the present invention adopts a loosely-coupled, hierarchical, and modular composition architecture to ensure independence among different layers and different object models and facilitate design changes and localization updating, supports the independent insertion of new technologies, and reduces the impact of technology refresh or technology degradation.

(4) Building a universal diagnosis model structure for the airborne health management domain can promote the normalization and standardization of the model software development process and improve the code quality and stability of model software.

(5) The object-oriented health management database is designed with high scalability, so it can keep a comprehensive record of state monitoring and diagnosis data of various objects of the airborne system for further intermittent fault analysis and complicated fault diagnosis off the aircraft.

(6) The method provided in the present invention can be used for the design and development of an aircraft comprehensive state monitoring and diagnosis system, with good economic benefits.

### BRIEF DESCRIPTION OF THE DRAWINGS

In order to illustrate the technical solutions in the embodiments of the present invention more clearly, the figures required for describing the embodiments will be introduced briefly. Obviously, the figures in the description below are just some of embodiments recorded in the embodiments of the present invention. Those of ordinary skilled in the art can further obtain other figures based on those drawings.

FIG. 1 is a schematic view of a multi-model fused avionic product health assessment method according to an embodiment of the present invention;

FIG. 2 is a schematic view of an optional avionic product health assessment process based on multi-model fusion according to an embodiment of the present invention;

FIGS. 3(a)-3(d) are schematic views of life-cycle degradation data of lithium-ion batteries according to an embodiment of the present invention, respectively;

FIG. 4 is a schematic view of a comparison of prediction results and the real degradation process according to an embodiment of the present invention;

FIG. 5 is a schematic view of a comparison of prediction results using the LSTM method and the real degradation process according to an embodiment of the present invention;

FIG. 6 is a schematic view of a comparison of prediction results using the BP neural network method and the real degradation process according to an embodiment of the present invention;

FIG. 7 is a schematic view of the external interface relationship of the airborne health management domain according to an embodiment of the present invention;

FIG. 8 is a schematic view of the state transition of the airborne health management domain according to an embodiment of the present invention;

FIG. 9 is a schematic view of interface messages of the airborne health management domain according to an embodiment of the present invention;

FIG. 10 is a schematic view of the hierarchical division of the airborne health management domain according to an embodiment of the present invention;

FIG. 11 is a schematic view of the universal diagnosis model structure of the airborne health management domain according to an embodiment of the present invention;

FIG. 12 is a schematic view of the data table relationship of the airborne health management domain according to an embodiment of the present invention.

### DESCRIPTION OF EMBODIMENTS

The present invention is further described in conjunction with the drawings and embodiments. Apparently, the embodiments as described are parts of the embodiments of the present invention, rather than all of the embodiments. All other embodiments obtained by those of ordinary skill in the art fall within the scope of protection of the embodiments of the present invention.

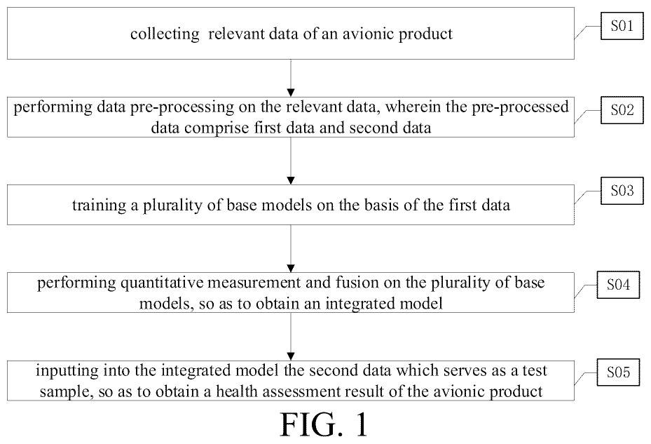

By referring to FIG. 1, the avionic product health assessment process based on multi-model fusion comprises:
Step 01: collecting relevant data of an avionic product;
Step 02: performing data pre-processing on the relevant data, wherein the pre-processed data comprise first data and second data;
Step 03: training a plurality of base models on the basis of the first data;
Step 04: performing quantitative measurement and fusion on the plurality of base models, so as to obtain an integrated model; and
Step 05: inputting into the integrated model the second data which serves as a test sample, so as to obtain a health assessment result of the avionic product.

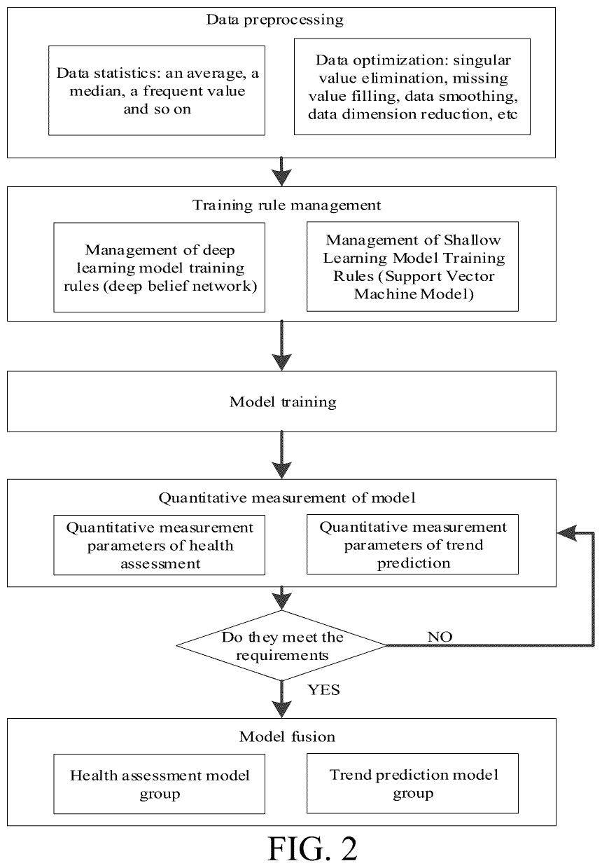

In an alternative embodiment, the avionic product health assessment process based on multi-model fusion is divided into 5 steps by referring to FIG. 2: 1) data pre-processing, including data statistics and data optimization; 2) training rule management, including deep learning model shallow learning model training rule management; 3) model training; 4) quantitative measurement of models, including quantitative measurement parameters of health assessment and trend prediction; 5) model group fusion, separately fusing health assessment model group and trend prediction model group.

Data pre-processing. Given that complex external stresses exist in the airborne environment and the accuracy of aircraft health assessment and prediction is seriously affected due to strong noise interference, data value exception, data loss, etc. in the data collected by sensors, it is necessary to preprocess massive data. data pre-processing comprises data statistics and data optimization: 1) data statistics is to manually extract static features to characterize the state of objects to be monitored by analyzing the statistical rules of data, and the statistical values include mean values, medians, frequent values, etc.; 2) data optimization is used to solve acquisition exceptions in practical engineering, such as existence of missing values and singular values, high data dimension, and high data fluctuation, and various methods, including singular value elimination, missing value filling, data smoothing, data dimension reduction, etc., are employed to process data and eliminate the impact of data problems on model training.

Training rule management. The intelligent diagnosis system is generally used by ground maintenance crew and on-board operators without having relevant expertise in intelligent diagnosis model rule management, so it is necessary to carry out black-box processing of the intelligent diagnosis model, summarize training rules, and describe all interfaces in detail. A training rule is a summary of data set structure definitions of training models, intrinsic mechanism characteristics of models, and hyperparameter and structure parameter settings, and file import and manual input interfaces are provided in the system.

For the shallow learning mode, the support vector machine is taken as an example, with the following training rules: 1) training set composition: composed of training data and labels, a training data matrix is [m,n], wherein m denotes the number of samples and n denotes the feature of each sample; a label matrix is [m,1], denoting classification label values corresponding to m samples; and a training sample size accounting for 70% of a total sample size by default. 2) testing set composition: having a data structure consistent with the training set and a test sample size accounting for 30% of the total sample size by default; and 3) a model hyperparameter comprises kernel selection, penalty term, and kernel coefficient for kernel function.

For the deep learning mode, the deep belief network is taken as an example, with the following training rules: 1) a training set: composed of training samples and prediction labels, wherein the feature number of the training samples depends on the number of channels for collecting data and a sample size required for each channel; a training data matrix is [m,n] and a label matrix is [m,1], denoting prediction label values of m samples; and a training sample size accounting for 70% of a total sample size by default. 2) a testing set: having a testing data matrix of [o,1], denoting o data besides the training sample; and a test sample size accounting for 30% of the total sample size by default; 3) a model structure parameter includes number of layers, attribute of each layer, number of neurons of each layer, etc.; and 4) a model hyperparameter includes number of epochs, batch size for training, learning rate, activation function, etc.

Model training. The model training process of machine learning models (SVM, LSTM, and DBN) is shown below:

Step 1: completing a model structure initialization according to the model structure parameter and the model hyperparameter in the training rule.

Step 2: inputting a batch of training model samples and performing a feedforward operation on the models to obtain an output value for the models corresponding to the samples.

Step 3: performing backpropagating refinement of an error in the label and the output value of the model sample based on the gradient descent algorithm and updating the internal weight and bias of the models.

Step 4: iteratively inputting the training sample until the error converges to or reaches the maximum iterations.

The training on the unscented particle filter model and the stochastic process model is to determine a prediction model and a prior distribution from historical data and continuously update a weight based on the sample to obtain a posterior distribution of states, thereby completing the updating of the prediction model.

Quantitative measurement of models. The quantitative measurement of models is executed after model training to perform the metric evaluation of the training effect of models and judge whether the models meet the on-board requirements. Model measurement is divided into two categories: health assessment and trend prediction.

1) The quantitative measurement parameters of health assessment mainly include: (1) accuracy: a total ratio of all correct classification results. (2) precision: a ratio of data correctly judged as one class to all data judged as the class.

2) The quantitative measurement parameters of trend prediction mainly include: (1) root-mean-square error: a square root of a ratio of a sum of squared error between an observed value and a true value to a number of observations, and the value is very sensitive to particularly large or small errors in the measurement, so that it can better reflect the precision of the measurement.

(2) mean absolute error: an average of an absolute value of an error between the observed value and the true value, and the value can avoid errors canceling each other out, so that it can accurately reflect the actual magnitude of errors. (3) correlation coefficient: its calculation formula of the correlation coefficient is shown as follows to measure the correlation intensity between the observed value and the true value,

$$r ( X , Y ) = \frac{cov ( X , Y )}{{\sqrt{Var \vert X \vert Var \vert Y \vert}}^{\\}} \qquad ( 1 )$$

wherein X is an observed value, Y is a true value, Cov(X,Y) is the covariance of X and Y, Var|X| is the variance of X, and Var|Y| is the variance of Y.

Model group fusion. The essence of model group fusion is the process of integrating some weak learners into one strong learner, which is aimed at maintaining the feature diversity of various models and improving the accuracy and generalization ability of the model output results. For the existing commonly-used fusion algorithms, such as weighted voting algorithm, average algorithm, and relative voting algorithm, only single model performance differences are considered to set voting weights, which cannot solve performance difference problems of different base models in different environments. In this paper, the Adaboosting algorithm is selected to optimize combined strategies, and the linear error function is used for loop iteration of each base model to obtain the weighting coefficients of a series of weak models. when assembling a sample set of

$$D = {\{ {x}_{i} , {y}_{i} \}}_{i = 1}^{N} ,$$

the number of base models is T; where xᵢ is the training data of the i-th sample, yᵢ is the label of the i-th sample, and N is the number of training samples. An integrated algorithm flow is as follows:
Step 1: Initialization: initializing an error weight W₁ of every sample in an ensemble sample set of a target scene. This weight is the magnitude of the effect of each sample on the final error synthesis. The initialization formula is shown below:

$${W}_{1} = ( {w}_{1 , 1} , {w}_{1 , 2} … {w}_{1 , N} ) , {w}_{1 , i} = \frac{1}{N} \qquad ( 2 )$$

where W_{1,i} is an error weight of the i-th sample impacting the final error and W_{1,N} is an error weight of the N-th sample impacting the final error;
Step 2: calculating the errors of the base models, and sequentially calculating the output hₜ of the base models, the maximum error Eₜ of the sample, the relative error eₙ of the i-th sample, and the prediction error rate εₜ of the base learner according to the following linear loss function formula;

$${E}_{t} = max \vert {y}_{i} - {h}_{t} ( {x}_{i} ) \vert , i = 1 , 2 … N \qquad ( 3 )$$

$${e}_{ti} = \frac{\vert {y}_{i} - {h}_{t} ( {x}_{i} ) \vert}{{E}_{t}} \qquad ( 4 )$$

$${ε}_{t} = {\sum }_{1}^{N} {w}_{t , i} {e}_{ti} \qquad ( 5 )$$

where hₜ(xᵢ) is a calculated result of the t-th base model with the i-th sample and W_{t,i} is an influence weight of the i-th sample in the t-th base model that impacts the final error;
Step 3: calculating the weight coefficient out of the base models with a calculation formula shown as follows:

$${α}_{t} = \frac{{ε}_{t}}{1 - {ε}_{t}} \qquad ( 6 )$$

Step 4: updating the error weight of the sample set, and sequentially calculating a generalization factor Zₜ, a new error weight W_{t+1,i} of the sample and a new error weight Wₜ₊₁ of the sample set, with the following calculation formulas:

$${Z}_{t} = {\sum }_{i = 1}^{N} {w}_{t , i} {α}_{t}^{1 - {e}_{ti}} \qquad ( 7 )$$

$${w}_{t + 1 , i} = \frac{{w}_{t , i}}{{Z}_{t}} {α}_{t}^{1 - {e}_{ti}} \qquad ( 8 )$$

$${W}_{t + 1} = ( {w}_{t + 1 , 1} , {w}_{t + 1 , 2} … {w}_{t + 1 , N} ) \qquad ( 9 )$$

where W_{t+i,N} is a new error weight of the N-th sample;
Step 5: repeating steps 2 to 4 until the prediction error rate is 0 or the number of base models reaches T; and
Step 6: calculating an ensemble output of the base models with a calculation formula shown as follows:

$$H ( x ) = {\sum }_{t = 1}^{T} ( ln \frac{1}{{α}_{t}} ) K \qquad ( 10 )$$

where K is a median of all base model outputs.

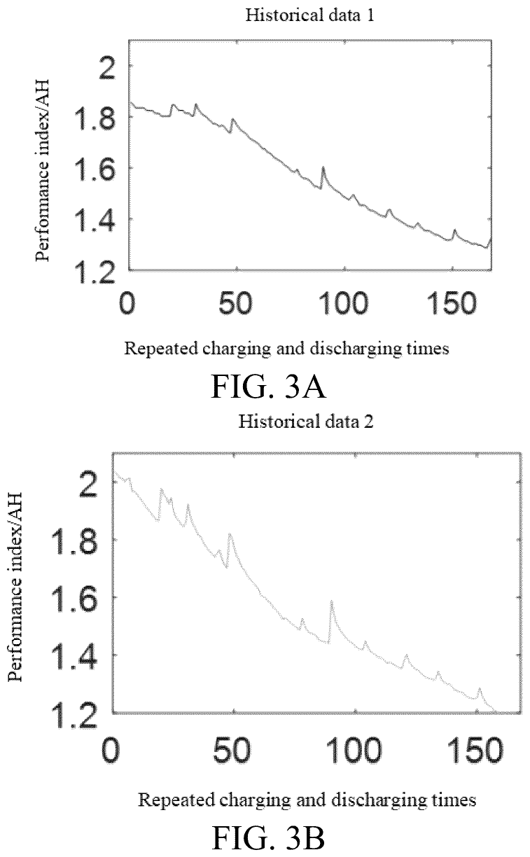

By referring to FIGS. 3(a)-3(d), aircraft batteries are the core components of the aircraft power system, which are mainly used to supply power to key systems in the aircraft in case of an exception in the main power supply. Now they have been widely used in a variety of aircraft platforms at home and abroad as the emergency supply and auxiliary power supply. If aircraft batteries fail during flight, the avionics system will be exposed to the danger of power failure, and even the failure may cause the loss of control of the entire aircraft with catastrophic consequences. Aircraft batteries mainly include nickel-cadmium batteries, lead-acid batteries, and lithium-ion batteries. As the lithium-ion battery process technology is becoming more mature, the advantages of lithium-ion batteries in service life, quality, and capacity are increasingly clear, and now lithium-ion batteries have gradually replaced nickel-cadmium and lead-acid batteries as the main batteries. Therefore, the method proposed in this paper is verified by using lithium-ion aircraft batteries as the research object, and the experiment data are based on 4 groups of lithium-ion battery data from NASA, which are shown in FIGS. 3(a) to 3(d).

In the verification experiment, 4 groups of lithium-ion battery data are preprocessed first to obtain 4 pre-processed data sets through data statistics and data optimization, the first to third pre-processed data sets are selected to construct training sample sets, and the fourth pre-processed data set is selected to construct verification sample sets and test sample sets. To verify the impact of the health assessment method proposed in this paper on the assessment and prediction effects, two comparison methods are set in the verification experiment, namely, LSTM and BP neural network, with the specific parameter setting shown as follows:
(1) Method proposed in this paper: the Adaboosting algorithm is used to integrate 5 classes of base models, comprising support vector machine, long short-term memory neural network, deep belief network, unscented particle filter model, and stochastic process model. The support vector machine selects the RBF kernel, the regularization parameter C is set to 0.5, and the Gamma parameter is set to 1; the structure setting of the LSTM model is separately [4 100 1], with the learning rate of 0.1, and the gradient descent algorithm with momentum is used for training, with the momentum of 0.8, the error convergence threshold is 0.01, and the maximum number of iterations is 300; the structure setting of the DBN model is separately [4 500 500 1], with the learning rate of 0.1, and the gradient descent algorithm with momentum is used for training, with the momentum of 0.8, the error convergence threshold is 0.01, and the maximum number of iterations is 300; the number of particles for unscented particle filter is set to 10; the expectation-maximization (EM) algorithm is employed in the stochastic process for assessing the Gamma process-based model.
(2) Classic LSTM: LSTM structure setting: the LSTM structure setting is [4 100 1], with the learning rate of 0.1, and the gradient descent algorithm with momentum is used for training, with the momentum of 0.8, the error convergence threshold is 0.01, and the maximum number of iterations is 300;
(3) Backpropagation network (BP): a neural network structure is [4 100 1], the same gradient descent algorithm with momentum is adopted, and the hyperparameter setting is consistent with that of the classic LSTM.

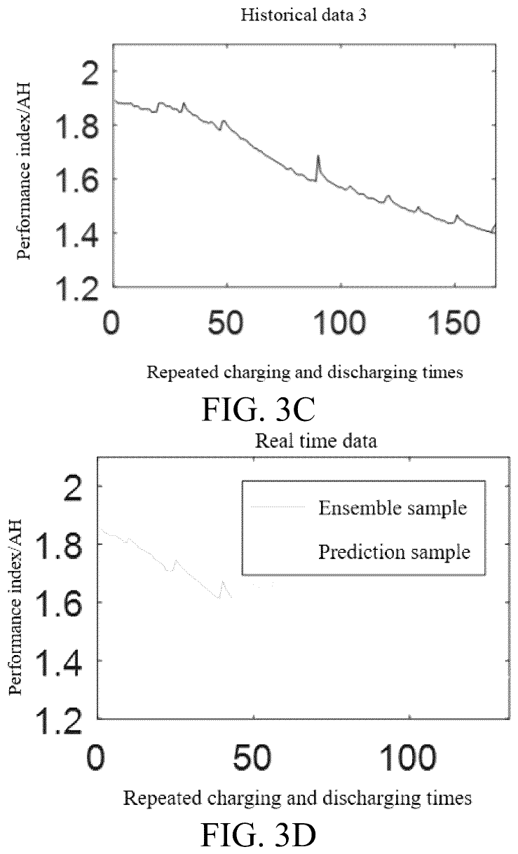

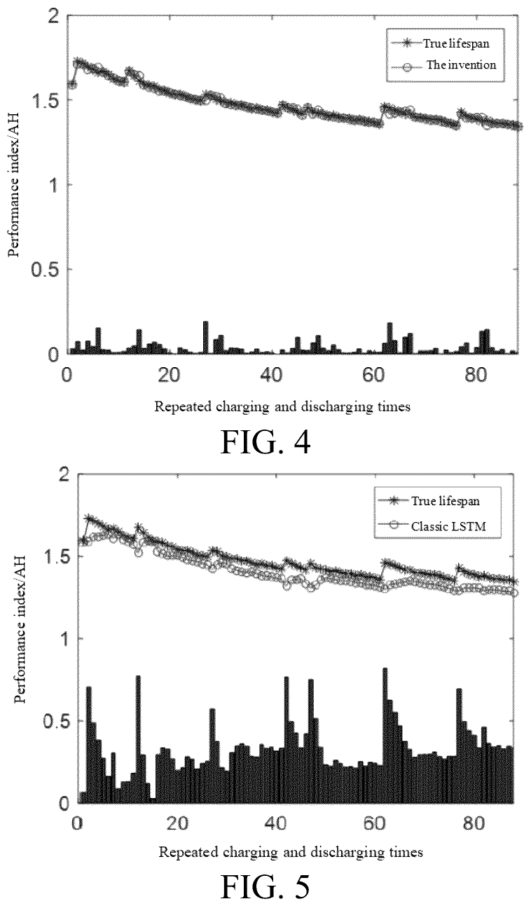

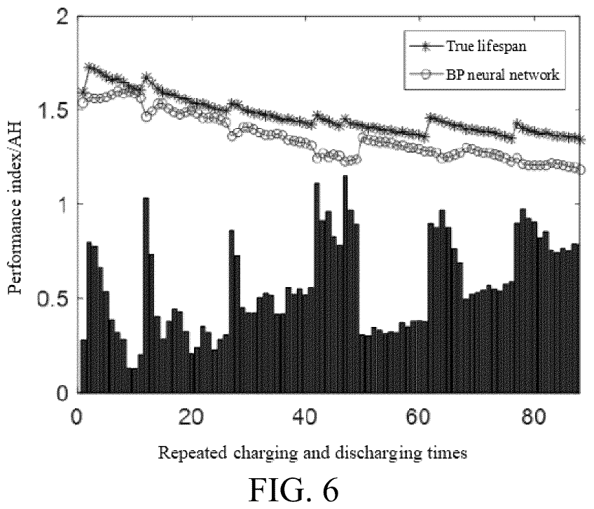

See FIGS. 4 to 6. FIGS. 4 to 6 illustrate the prediction effect comparison of 2 comparison methods with the method proposed in the present invention. To improve the visualization effect of prediction results, the value illustrated in the lower part of each figure is 5 times the difference between the real service life and the predicted one. In this paper, the prediction results are measured by three factors: root-mean-square error (RMSE), mean absolute error (MAE), and relevance (REL), and the results of comparative analysis are shown in Table 1.

TABLE 1
Results of Comparative Analysis

| | RMSE | MAE | REL |
|---|---|---|---|
| BP neural network | 0.114 | 0.113 | 0.706 |
| Classic LSTM model | 0.062 | 0.059 | 0.882 |
| Method proposed in this paper | 0.028 | 0.011 | 0.979 |

In an alternative embodiment, Step 01: the step of collecting relevant data of an avionic product comprises:
setting a data processing and distribution layer on a data acquisition and preprocessing layer; wherein the data processing and distribution layer, the data acquisition and preprocessing layer, a data transmission layer and a display control and storage layer together form an aircraft comprehensive state monitoring and diagnosis system, and the data acquisition and preprocessing layer collects, preprocesses and encapsulates state monitoring data of the airborne system to form a state monitoring data packet, and uploads the state monitoring data packet to the airborne health management domain through the data transmission layer.

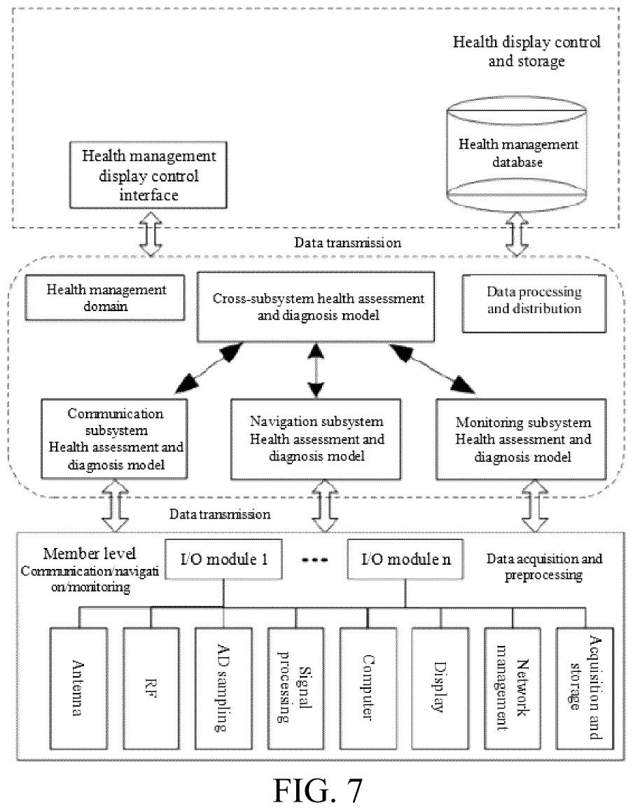

By referring to FIG. 7, the airborne health management domain is in the aircraft comprehensive state monitoring and diagnosis system. The biggest difference between the aircraft comprehensive state monitoring and diagnosis system and the traditional BIT system is that: from the perspective of professional focus, a data processing and distribution layer is designed on the member-level health data acquisition and preprocessing layer, namely, airborne health management domain. The airborne health management domain integrates all kinds of intelligent reasoning algorithms and a variety of health assessment and diagnosis models, maximizes the use of all types of state monitoring data collected from the bottom layer, improves the system health perception and diagnosis capability, and supports the intelligent scheduling management and autonomous support of sensors.

The aircraft comprehensive state monitoring and diagnosis system can be logically divided into four parts: data acquisition and preprocessing, data transmission, data processing and distribution, and display control and storage. The airborne health management domain is mainly used to realize the data processing and distribution function, including a plurality of member-subsystem health management models and cross-subsystem health management model software. After analyzing the health information about modules, functions, and networks collected by each area management unit, the health management domain completes the integrated fault diagnosis and function assessment, forms fault logs, and distributes and reports health information as needed.

The airborne health management domain establishes the interface relationship with the data acquisition and preprocessing part through the data transmission part downwards. The data acquisition and preprocessing layer collects, preprocesses, and encapsulates state monitoring data of the airborne system to form a state monitoring data packet, and uploads the state-monitoring data packet to the airborne health management domain through the data transmission layer.

The data transmission part is divided into two categories: one is the member-level internal health data transmission, with the transmission means including CAN bus, RS485 bus, 100 megabit network, gigabit network, etc., wherein the CAN bus is used for transmitting module health data in the rack; the RS485 bus and the 100 megabit network are used for health data transmission of various stand-alone devices, antenna interface units or antennas; the gigabit network is used for health data transmission of the display & control computer module. The other is the large-scale health data transmission between various member-subsystem and system health management domains and the health display control and storage server, and the 10GbE fiber optic network is mainly used.

The airborne health management domain establishes the interface relationship with the display control and storage part through the data transmission upwards, wherein the display control unit provides the corresponding health information display and control interface according to different users, such as flight crew, ground crew, and maintenance personnel, and completes the display of health state information about functions, modules, and bus network and the control function of maintenance BIT process. The storage unit completes the storage of different levels of health state information by using the database.

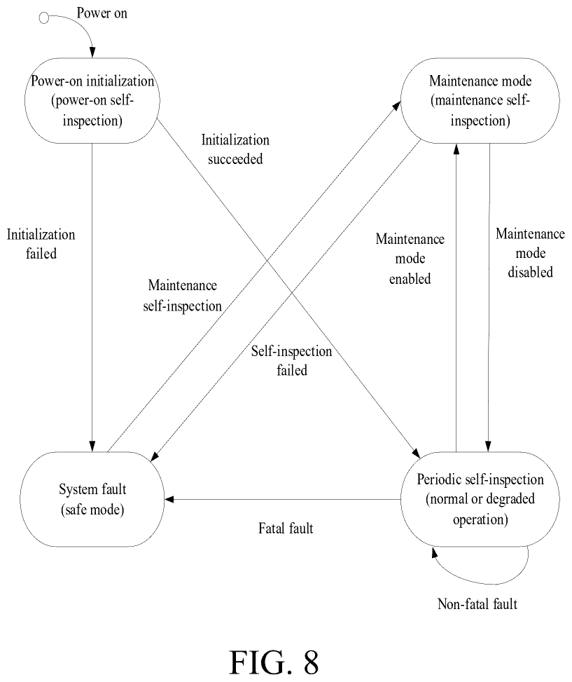

In an alternative embodiment, by referring to FIG. 8, the avionic product health assessment method based on multi-model fusion further comprises the following sub-steps:
classifying the state of the airborne health management domain into four types: power-on BIT state, periodic BIT state, maintenance BIT state and fault state;
wherein the power-on BIT state is a BIT state which the airborne health management domain will automatically enter after the aircraft is powered on, and in this state, the airborne system performs the power-on BIT, bus network node state detection, and functional thread link resource BIT of modules; wherein the periodic BIT state is a BIT state which the airborne health management domain will automatically enter after initialization succeeds, and in this state, the airborne system detects airborne bus network node state, key hardware resources, and software operation state periodically without interrupting the normal operation of the system itself;
wherein the maintenance BIT is a deep BIT state performed in the maintenance mode, and in this state, the airborne health management domain has all resource control permissions and complete fault detection and isolation capabilities to start the maintenance BIT process for single or multiple functions and modules, and sets BIT parameters for the query and setting of fault thresholds;
wherein the system fault state is a state which the airborne system enters after initialization fails or a fatal fault occurs, and in this state, switching to the maintenance BIT state through maintenance BIT, and if maintenance BIT fails, returning to the system fault state.

If the power-on initialization succeeded, switching from the power-on BIT state to the periodic BIT state; if the power-on initialization failed, switching from the power-on BIT state to the fault state; in the periodic BIT state, if a fatal fault occurs, switching to the fault state, and if a maintenance BIT command is received, enabling the maintenance BIT state;
in the fault state, if the maintenance BIT command is received, enabling the maintenance BIT state; and in the maintenance BIT state, if the maintenance BIT failed, switching to the fault state, and if an exit-maintenance-mode command is received, switching to the periodic BIT state.

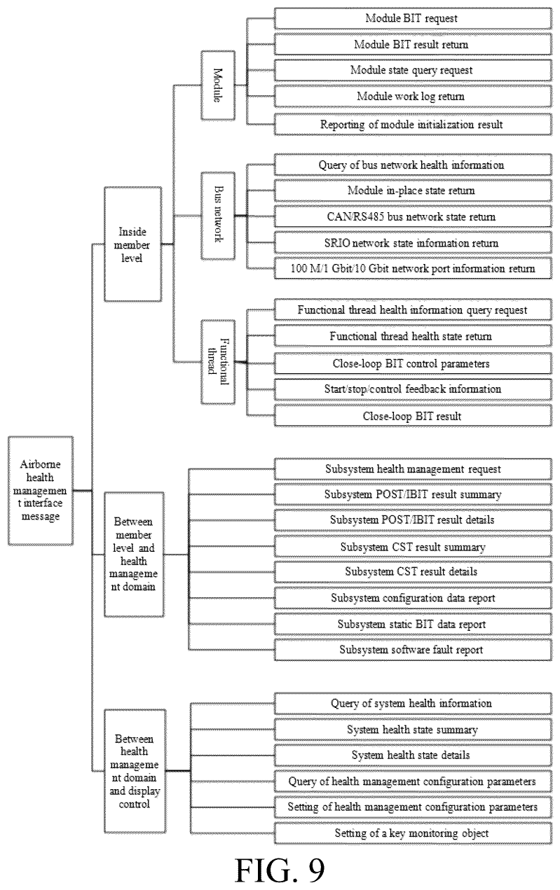

In an alternative embodiment, the avionic product health assessment method based on multi-model fusion further comprises the following sub-steps:
dividing an interface message of the aircraft comprehensive state monitoring and diagnosis system; by referring to FIG. 9, dividing an external interface message of the airborne health management domain into an interface message between the data acquisition and preprocessing layer and the airborne health management domain and an interface message between the airborne health management domain and the display control and storage layer.

More particularly, the interface message between the data acquisition and preprocessing layer and the airborne health management domain is subdivided into eight message types, namely, subsystem health management request, subsystem power-on BIT/startup BIT result summary, subsystem power-on BIT/startup BIT result detail, subsystem periodic BIT result summary, subsystem periodic BIT result detail, subsystem configuration data report, subsystem static BIT data report, and subsystem software fault report.

More particularly, the interface message between the airborne health management domain and the display control and storage layer is subdivided into six message types, namely, system health information inquiry, system health state summary, system health state detail, health management configuration parameter inquiry, health management configuration parameter setting, and key health object setting.

In an alternative embodiment, the avionic product health assessment method based on multi-model fusion further comprises the following sub-steps:
dividing the model hierarchies of the airborne health management domain;

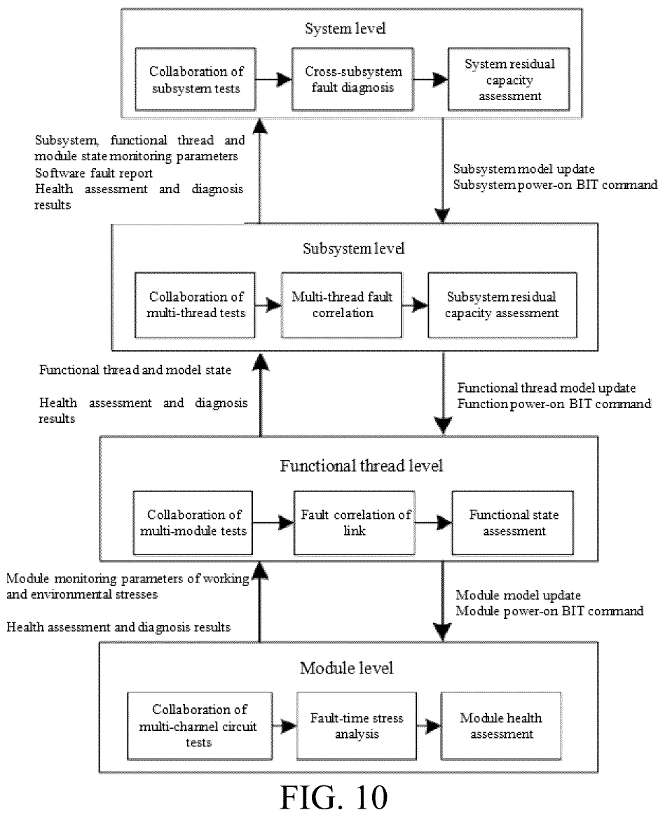

Referring to FIG. 10, to facilitate the development and integration of various algorithm models, the airborne health management domain is designed with a loosely-coupled, hierarchical, and modular open model architecture, and the following design principle is followed:
1) The dedicated information of the member subsystem, such as structure, behavioral model data, and interface code, should be included in the subsystem model;
2) The general algorithm should be separated from the subsystem model and developed independently with the subsystem-specific diagnosis knowledge model;
3) The subsystem-specific algorithms should be included in the subsystem model;
4) The model database should be loaded based on the system configuration, and the initialization model configuration should be reported based on the subsystem hardware/software configuration. Based on the principles, the hierarchical division of the airborne health management domain should be consistent with the physical or logical structure division of the system itself and be divided into four levels: a module level, a functional thread level, a subsystem level and a system level, and the tasks, input information, and output information should be set at each level.

In the embodiment, the tasks at the module level are collaborative management and control of tests among multi-channel circuit units in a module, a fault-time stress analysis and a module health assessment;
the input at the module level comprises a module model update command and a module power-on BIT command;
the output at the module level comprises module monitoring parameters of working and environmental stresses and module health assessment and diagnosis results;
the tasks at the functional thread level are collaborative management and control of multi-module tests, a fault correlation analysis among the modules and a functional health state assessment;
the input at the functional thread level comprises the module monitoring parameters of working and environmental stresses as well as the module health assessment and diagnosis results of the output at the module level and a functional thread model update command and a function power-on BIT command of the input at the subsystem level;
the output at the functional thread level comprises a functional thread state monitoring parameter and functional health assessment and diagnosis results;
the tasks at the subsystem level are collaborative management and control of multi-thread tests, a multi-thread fault correlation analysis and a subsystem residual capacity assessment;
the input at the subsystem level comprises the functional thread state monitoring parameter as well as the functional health assessment and diagnosis results of the output at the functional thread level and a subsystem model update command and a subsystem power-on BIT command of the input at the system level;
the output at the subsystem level comprises a subsystem state monitoring parameter, a software fault report, and subsystem health assessment and diagnosis results;
the tasks at the system level are collaborative management and control of tests among the subsystems, cross-subsystem fault diagnosis and a system residual capacity assessment;
the input at the system level comprises the subsystem state monitoring parameter, the software fault report, and the subsystem health assessment and diagnosis results of the output at the subsystem level; and
the output at the system level comprises system health state summary and system health state details.

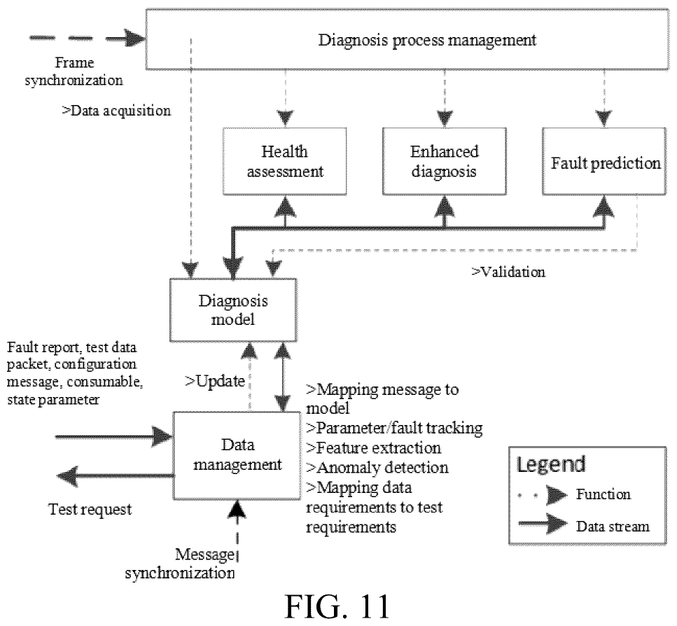

In an alternative embodiment, the avionic product health assessment method based on multi-model fusion further comprises the following sub-steps:
building a health assessment and diagnosis model of the airborne health management domain;
by referring to FIG. 11, the airborne health management domain is composed of health assessment and diagnosis models of different objects at different levels and a universal health assessment and diagnosis model structure should be defined to facilitate the development of model software. The health assessment and diagnosis model consists of data management, diagnosis model, health assessment, enhanced diagnosis, fault prediction, and diagnosis process management units.

The data management unit is a converter between the external input data and the diagnosis model, responds to the fault report, test data packet, configuration message, consumable, and state parameter message input, updates local cache based on the messages, maps the messages to the diagnosis model, and reacts to parameter changes and fault indications by triggering the updating of the diagnostic model. The data management unit also manages the test requests to the subsystem and establishes the mapping between data requests and test requests.

The diagnosis model, as a knowledge base of system diagnosis states, is defined as a database structure object or a node containing related programs, including prior knowledge related to diagnosis, such as parameter state, fault duration, prerequisite and association with model nodes. For the airborne system, the diagnosis model should reflect the randomness and intermittence of faults and the uncertain behaviors of horizontal and vertical transmission of faults in a hierarchical structure model of complex systems.

The health assessment unit realizes the abnormal detection and state assessment of the functional thread and the module as well as the system-level residual capacity assessment. For the functional thread and module of the airborne system, the health assessment unit identifies the fault modes for the functional thread or module through the abnormal detection and fault-time stress analysis based on the synthesis of multiple parameters and also determines the intermittent faults under a working and environmental stress condition. The system residual capacity assessment is mainly to assess the residual capacity of the current or future system by integrating the current or future health states (normal, failure, or degradation) of all functional threads and modules and combining the current working mode and resource allocation of the system or the system working mode and resource allocation to be configured by the aircraft tasks in the future.

The enhanced diagnosis unit adopts a universal diagnosis inference engine relatively independent of the diagnosis model development to realize functions such as fault tracing, fault validation, and fault correlation analysis (correlative fault elimination, false alarm, and identification of missed inspection). For the airborne system, the diagnosis inference engine design needs to overcome test evidence unreliability, uncertainty of fault propagation, coexistence of multiple faults, and other engineering application challenges. To reduce the presence of ambiguity groups, the diagnosis process may require additional test data to generate test requests to the subsystem.

The fault prediction unit adopts a prediction method based on a feature trend and carries out predictions about some products or components with an obvious degradation feature and a traceable fault rule, such as analog/RF circuit performance degradation (a phenomenon that may cause performance drift due to aging, environment or component manufacturing process), communication error (link nonrandomness or excessive loss of communication information caused by degradation), and DC voltage drift. The on-board fault prediction mainly completes data collection, parameter degradation trend tracking, and prediction feature extraction, and the remaining service life estimation is completed off the aircraft.

The diagnosis process management unit realizes the collaborative management of the model-input data sets and the health assessment, enhanced diagnosis and fault prediction processes. The health assessment unit outputs the health state of functional threads and models: normal, fault, or degradation. For the fault state, the enhanced diagnosis process is enabled, the correlative fault or false alarm is eliminated, and the fault cause is finalized; for the degradation state, the fault prediction process is enabled, the degradation mode is matched, the degradation trend is analyzed, and the occurrence time of a fault is predicted. The results of enhanced diagnosis and fault prediction are fed back to the health assessment unit, thus providing input for the system residual capacity assessment.

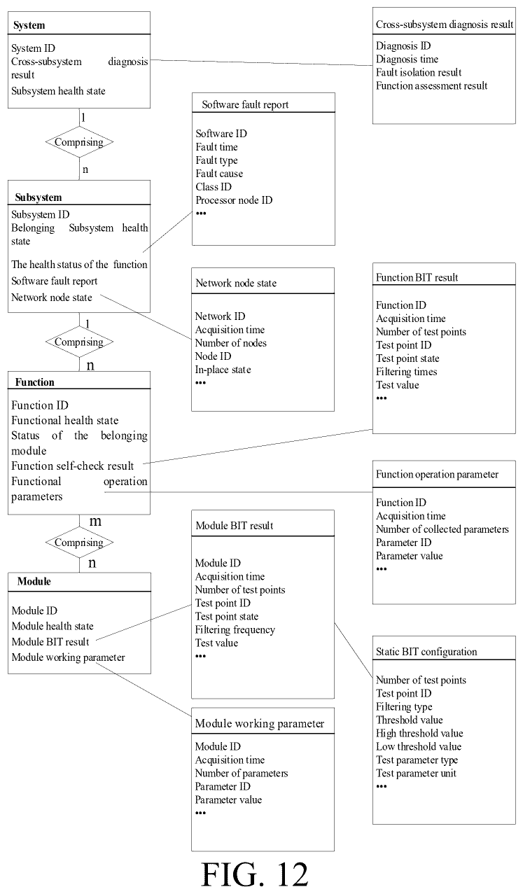

In an alternative embodiment, the avionic product health assessment method based on multi-model fusion further comprises the following sub-steps:
dividing a database table of the airborne health management domain to obtain a plurality of data tables; By referring to FIG. 12, the airborne health management domain database is based on the object-oriented design philosophy, wherein system, subsystem, functional thread, and module are used as objects and the data structure of high cohesion and low coupling is designed to form the health data record tables of objects at various levels and meet the multi-level architecture features of the airborne system. The database table of the airborne health management domain is divided into a system table, a cross-subsystem diagnosis result table, a subsystem table, a software fault report table, a network node state table, a function table, a function BIT result table, a function operation parameter table, a module table, a module BIT result table, a module working parameter table and a static BIT configuration table,
wherein the system table comprises a system identifier, a cross-subsystem diagnosis result and subsystem health state summary;
the cross-subsystem diagnosis result table comprises a diagnosis result identifier, a diagnosis time, a fault isolation result, and function assessment result information;
the subsystem table comprises a subsystem identifier, subsystem health state details, a function identifier it belongs to, the software fault report, and network node state information; the software fault report table comprises a software identifier, a fault time, a fault type, a class identifier and a processor node identifier;
the network node state table comprises a network identifier, an acquisition time, the number of nodes, a node identifier, and node state;
the function table comprises a function identifier, a function health state, a module identifier it belongs to, a function BIT result, and function operation parameter information;
the function BIT result table comprises a function identifier, an acquisition time, the number of test points, a test point identifier or a test point ID, and test point state;
the function operation parameter table comprises a function identifier, an acquisition time, the number of parameters, a parameter identifier or a parameter ID and a parameter value;
the module table comprises a module identifier, a module health state, a module BIT result and a module working parameter;
the module BIT result table comprises a module identifier, an acquisition time, the number of test points, a test point identifier, and test point state;
the module working parameter table comprises a module identifier, an acquisition time, a parameter identifier and a parameter value; and
the static BIT configuration table comprises the number of test points, a test point identifier, a filtering type, a threshold value and a test parameter type.

In an alternative embodiment, the avionic product health assessment method based on multi-model fusion further comprises the following sub-steps:
forming associations between data tables.

The system table is associated with the cross-subsystem diagnosis result table through the diagnosis result identifier, and with the subsystem table through the subsystem identifier it belongs to;

the subsystem table is associated with the software fault report table through the software identifier, with the network node state table through the network identifier, and with the function table through the function identifier it belongs to;
the function table is associated with the function BIT result table and the function operation parameter table through the function identifier, and with the module table through the module identifier it belongs to; and
the module table is associated with the module BIT result table and the module working parameter table through the module identifier, and with the static BIT configuration table through the test point identifier.

Finally, it should be noted that the above embodiments are only considered to be illustrative for the technical solutions of the present invention instead of limitation thereto. Although the present invention is described in detail in combination with the above embodiments, those of ordinary skill in the art shall understand that they can still modify or perform equivalent replacement on implementations of the present invention and any modification or equivalent replacement made within the spirit and rule of the present invention shall be incorporated in the protection scope of the present invention.

### Industrial Applicability

The technical solutions provided by the embodiments of the present invention are capable of being applied to the technical field of health assessment. In the embodiments of the present invention, relevant data of an avionic product are collected; data pre-processing is performed on the relevant data, wherein the pre-processed data comprise first data and second data; a plurality of base models are trained on the basis of the first data; a quantitative measurement and fusion are performed on the plurality of base models, so as to obtain an integrated model; and inputting into the integrated model the second data which serves as a test sample, so as to obtain a health assessment result of the avionic product. According to the embodiments of the present invention, a reference can be provided for a method based on data driving in terms of application in the health assessment, prediction and management of an avionic product.

1. A multi-model fused avionic product health assessment method, comprising:
collecting relevant data of an avionic product;
performing data pre-processing on the relevant data, wherein the pre-processed data comprise first data and second data;
training a plurality of base models on the basis of the first data;
performing quantitative measurement and fusion on the plurality of base models, so as to obtain an integrated model; and
inputting into the integrated model the second data which serves as a test sample, so as to obtain a health assessment result of the avionic product.

2. The method according to claim 1, wherein the relevant data are a parameter representing health state of the avionic product; the parameter includes at least one of the following: a working voltage value, a current value, a temperature value, loading state, a clock lock mark and a signal amplitude of the avionic product;
the data pre-processing comprises data statistics and data optimization; a statistical value of the data statistics includes at least one of the following: an average, a median and a frequent value; and a method for the data optimization includes at least one of the following: singular value elimination, missing value filling, data smoothing and data dimension reduction.

3. The method according to claim 1, wherein the plurality of base models at least comprises a machine learning model, an unscented particle filter model and a stochastic process model; wherein, the machine learning model includes at least one of the following: a support vector machine, a long short-term memory neural network and a deep belief network.

4. The method according to claim 3, wherein the training rule of the support vector machine comprises:
training set composition: composed of training data and labels, a training data matrix is [m,n], wherein m is a number of samples and n is a feature of each sample; a label matrix is [m,1], denoting classification label values corresponding to m samples; and a training sample size accounting for 70% of a total sample size;
testing set composition: having a data structure consistent with the training set, a test sample size accounting for 30% of the total sample size; and
a model hyperparameter includes at least one of the following: kernel selection, penalty term and kernel coefficient for kernel function.

5. The method according to claim 3, wherein a training rule of the deep belief network comprises:
a training set: composed of training samples and prediction labels, wherein a feature number of the training samples depends on a number of channels for collecting data and a sample size required for each channel; a training data matrix is [m,n] and a label matrix is [m, 1], denoting prediction label values of m samples; and a training sample size accounting for 70% of a total sample size;
a testing set: having a testing data matrix of [0,1], denoting o data besides the training sample; and a test sample size accounting for 30% of the total sample size;
a model structure parameter includes at least one of the following: a number of layers, an attribute of each layer and a number of neurons of each layer; and
a model hyperparameter includes at least one of the following: a number of epochs, a batch size for training, a learning rate and an activation function.

6. The method according to claim 3, wherein a training on the unscented particle filter model and the stochastic process model is to determine a prediction model and a prior distribution from historical data, and continuously update a weight according to the samples to obtain a posterior distribution of states, thereby completing the updating of the prediction model.

7. The method according to claim 1, wherein the step of training a plurality of base models on the basis of the first data comprises:
completing a model structure initialization according to the model structure parameter and the model hyperparameter in the training rule;
using the first data as the training sample and performing a feedforward operation on the models to obtain an output value from the models corresponding to the training sample;
performing backpropagating refinement of an error between the label and the output value of the training sample based on the gradient descent algorithm and updating an internal weight and bias of the models; and
iteratively inputting the training sample until the error converges to or reaches the maximum iterations.

8. The method according to claim 1, wherein the quantitative measurement is divided into two categories, namely, a health assessment and a trend prediction; wherein, the quantitative measurement parameter of the health assessment includes at least one of the following: accuracy rate and precision rate; wherein, the accuracy rate indicates a ratio of all correct classification results to all classification results; and the precision rate indicates a ratio of data correctly judged as one class to all data judged as the class;
the quantitative measurement parameter of the trend prediction adopts at least one of the following: a root-mean-square error, a mean absolute error and a correlation coefficient; wherein, the root-mean-square error is a square root of a ratio of a sum of squared error between an observed value and a true value to a number of observations; the mean absolute error is an average of an absolute value of an error between the observe value and the true value; and a calculation formula of the correlation coefficient is shown as follows:
$$r ( X , Y ) = \frac{cov ( X , Y )}{{\sqrt{Var \vert X \vert Var \vert Y \vert}}^{\\}} \qquad ( 1 )$$
where X is the observed value, Y is the true value, Cov(X, Y) is the covariance between X and Y, Var|X| is the variance of X, and Var|Y| is the variance of Y.

9. The method according to claim 1, wherein in the process of performing quantitative measurement and fusion on the plurality of base models, so as to obtain an integrated model:
adopting the Adaboosting algorithm to optimize the combined strategy and adopting a linear error function to iterate over each base model to get a weight coefficient for a set of weak models;
when assembling a sample set of
$$D = {\{ {x}_{i} , {y}_{i} \}}_{i = 1}^{N} ,$$
the number of base models is T; where xᵢ is the training data of the i-th sample, yᵢ is the label of the i-th sample, and N is the number of training samples.

10. The method according to claim 9, wherein a process of obtaining the integrated model comprises:
an initialization: initializing an error weight W₁ of an ensemble sample set of a target scene with an initialization formula shown as follows:
$${W}_{1} = ( {w}_{1 , 1} , {w}_{1 , 2} … {w}_{1 , N} ) , {w}_{1 , i} = \frac{1}{N} \qquad ( 2 )$$
where, W_{1,i} is an error weight of the i-th sample impacting the final error, and W_{1,N} is an error weight of the N-th sample impacting the final error;
calculating the errors of the base models, and sequentially calculating the output hₜ of the base models, the maximum error Eₜ of the sample, the relative error eₙ of the i-th sample and the prediction error rate εₜ of the base learner according to the following linear loss function formula;
$${E}_{t} = max \vert {y}_{i} - {h}_{t} ( {x}_{i} ) \vert , i = 1 , 2 … N \qquad ( 3 )$$
$${e}_{ti} = \frac{\vert {y}_{i} - {h}_{t} ( {x}_{i} ) \vert}{{E}_{t}} \qquad ( 4 )$$
$${ε}_{t} = {\sum }_{1}^{N} {w}_{t , i} {e}_{ti} \qquad ( 5 )$$
where hₜ(xᵢ) is a calculated result of the f-th base model with the i-th sample and W_{t,i} is an influence weight of the i-th sample in the t-th base model that impacts the final error;
calculating the weight coefficient αₜ of the base models with a calculation formula shown as follows:
$${α}_{t} = \frac{{ε}_{t}}{1 - {ε}_{t}} \qquad ( 6 )$$
updating the error weight of the sample set, and sequentially calculating a generalization factor Zₜ, a new error weight W_{t+1,i} of the sample and a new error weight Wₜ₊₁ of the sample set, with the following calculation formulas:
$${Z}_{t} = {\sum }_{i = 1}^{N} {w}_{t , i} {α}_{t}^{1 - {e}_{ti}} \qquad ( 7 )$$
$${w}_{t + 1 , i} = \frac{{w}_{t , i}}{{Z}_{t}} {α}_{t}^{1 - {e}_{ti}} \qquad ( 8 )$$
$${W}_{t + 1} = ( {w}_{t + 1 , 1} , {w}_{t + 1 , 2} … {w}_{t + 1 , N} ) \qquad ( 9 )$$
where W_{t+1,N} is a new error weight of the N-th sample;
repeating steps 42 to 44 until the prediction error rate is 0 or the number of base models reaches T, calculating an ensemble output of the base models with a calculation formula shown as follows:
$$H ( x ) = {\sum }_{t = 1}^{T} ( ln \frac{1}{{α}_{t}} ) K \qquad ( 10 )$$
where K is a median of all base model outputs.

11. The method according to claim 1, wherein the step of collecting relevant data of an avionic product comprises:
setting a data processing and distribution layer on a data acquisition and preprocessing layer; wherein, the data processing and distribution layer, the data acquisition and preprocessing layer, a data transmission layer and a display control and storage layer together form an aircraft comprehensive state monitoring and diagnosis system, and the data processing and distribution layer is the airborne health management domain; and
the data acquisition and preprocessing layer collects, preprocesses and encapsulates state monitoring data of the airborne system to form a state monitoring data packet, and uploads the state monitoring data packet to the airborne health management domain through the data transmission layer to obtain the relevant data of the avionic product.

12. The method according to claim 11, wherein the method further comprises:
classifying the state of the airborne health management domain into four types: power-on BIT state, periodic BIT state, maintenance BIT state and fault state;
if the power-on initialization succeeded, switching from the power-on BIT state to the periodic BIT state; if the power-on initialization failed, switching from the power-on BIT state to the fault state;
in the periodic BIT state, if a fatal fault occurs, switching to the fault state, and if a maintenance BIT command is received, enabling the maintenance BIT state; and
in the fault state, if the maintenance BIT command is received, enabling the maintenance BIT state;
and in the maintenance BIT state, if the maintenance BIT failed, switching to the fault state, and if an exit-maintenance-mode command is received, switching to the periodic BIT state.

13. The method according to claim 11, wherein the method further comprises:
dividing an external interface message of the airborne health management domain into an interface message between the data acquisition and preprocessing layer and the airborne health management domain and an interface message between the airborne health management domain and the display control and storage layer.

14. The method according to claim 11, wherein the method further comprises:
dividing the airborne health management domain into four levels: a module level, a functional thread level, a subsystem level and a system level, and setting tasks, input information and output information at each level.

15. The method according to claim 14, wherein the tasks at the module level are collaborative management and control of tests among multi-channel circuit units in a module, a fault-time stress analysis and a module health assessment;
the input at the module level comprises at least one of the following: a module model update command and a module power-on BIT command;
the output at the module level comprises at least one of the following: module monitoring parameters of working and environmental stresses, module health assessment and diagnosis results;
the tasks at the functional thread level are collaborative management and control of multi-module tests, a fault correlation analysis among the modules and a functional health state assessment;
the input at the functional thread level comprises at least one of the following: the module monitoring parameters of working and environmental stresses as well as the module health assessment and diagnosis results of the output at the module level and a functional thread model update command and a function power-on BIT command of the input at the subsystem level;
the output at the functional thread level comprises at least one of the following: a functional thread state monitoring parameter, and functional health assessment and diagnosis results;
the tasks at the subsystem level are collaborative management and control of multi-thread tests, a multi-thread fault correlation analysis and a subsystem residual capacity assessment;
the input at the subsystem level comprises at least one of the following: the functional thread state monitoring parameter as well as the functional health assessment and diagnosis results of the output at the functional thread level and a subsystem model update command and a subsystem power-on BIT command of the input at the system level;
the output at the subsystem level comprises at least one of the following: a subsystem state monitoring parameter, a software fault report and subsystem health assessment and diagnosis results;
the tasks at the system level are collaborative management and control of tests among the subsystems, cross-subsystem fault diagnosis and a system residual capacity assessment;
the input at the system level comprises at least one of the following: the subsystem state monitoring parameter, the software fault report and the subsystem health assessment and diagnosis results of the output at the subsystem level; and
the output at the system level comprises at least one of the following: system health state summary and system health state details.

16. The method according to claim 11, wherein the method further comprises:
modeling the health assessment and diagnosis of the airborne health management domain based on a data management unit, a diagnosis model, a health assessment unit, an enhanced diagnosis unit, a fault prediction unit and a diagnosis process management unit that are constructed.

17. The method according to claim 16, wherein the data management unit responds to key information, updates local cache, maps external input information to the diagnosis model and completes the conversion between external input data and the diagnosis model; the key information comprises at least one of the following: a fault report, a test data packet, a configuration message, a consumable and a state parameter that are input externally;
the diagnosis model manages prior knowledge related to system diagnosis state;
the health assessment unit performs abnormal detection of the functional thread and the module as well as the system-level residual capacity assessment;
the enhanced diagnosis unit adopts a universal diagnosis inference engine which is relatively independent from the diagnosis model to perform fault tracing, a fault validation and the fault correlation analysis;
the fault prediction unit adopts a prediction method based on a feature trend, and carries out data acquisition, parameter degradation trend tracking and prediction feature extraction for a product or a component with an obvious degradation feature and a traceable fault rule;
the diagnosis process management unit cooperatively manages a model-input data set as well as a health assessment, an enhanced diagnosis and a fault prediction process, transmits fault or return state of the functional thread and the module output by the health assessment unit to the enhanced diagnosis unit or the fault prediction unit, eliminates a correlative fault, matches a degradation mode and predicts the occurrence time of a fault; and
the diagnosis process management unit feeds the output results of the enhanced diagnosis unit and the fault prediction unit back to the health assessment unit, thus providing input for the airborne system residual capacity assessment.

18. The method according to claim 11, wherein the method further comprises:
dividing a database table of the airborne health management domain into a system table, a cross-subsystem diagnosis result table, a subsystem table, a software fault report table, a network node state table, a function table, a function BIT result table, a function operation parameter table, a module table, a module BIT result table, a module working parameter table and a static BIT configuration table;
wherein the system table comprises at least one of the following: a system identifier, a cross-subsystem diagnosis result and subsystem health state summary;
the cross-subsystem diagnosis result table comprises at least one of the following: a diagnosis result identifier, a diagnosis time, a fault isolation result and function assessment result information;
the subsystem table comprises at least one of the following: a subsystem identifier, subsystem health state details, a function identifier it belongs to, the software fault report and network node state information;
the software fault report table comprises at least one of the following: a software identifier, a fault time, a fault type, a class identifier and a processor node identifier;
the network node state table comprises at least one of the following: a network identifier, an acquisition time, a number of nodes, a node identifier and node state;
the function table comprises at least one of the following: the function identifier, the function health state, a module identifier it belongs to, a function BIT result and function operation parameter information;
the function BIT result table comprises at least one of the following: the function identifier, the acquisition time, a number of test points, a test point identifier or a test point ID, and test point state;
the function operation parameter table comprises at least one of the following: the function identifier, the acquisition time, a number of parameters, a parameter identifier or a parameter ID and a parameter value;
the module table comprises at least one of the following: the module identifier, module health state, a module BIT result and a module working parameter;
the module BIT result table comprises at least one of the following: the module identifier, the acquisition time, the number of test points, the test point identifier and the test point state;
the module working parameter table comprises at least one of the following: the module identifier, the acquisition time, the parameter identifier and the parameter value; and
the static BIT configuration table comprises at least one of the following: the number of test points, the test point identifier, a filtering type, a threshold value and a test parameter type.

19. The method according to claim 18, wherein the method further comprises:
the system table is associated with the cross-subsystem diagnosis result table through the diagnosis result identifier, and with the subsystem table through the subsystem identifier it belongs to;
the subsystem table is associated with the software fault report table through the software identifier, with the network node state table through the network identifier, and with the function table through the function identifier it belongs to;
the function table is associated with the function BIT result table and the function operation parameter table through the function identifier, and with the module table through the module identifier it belongs to; and
the module table is associated with the module BIT result table and the module working parameter table through the module identifier, and with the static BIT configuration table through the test point identifier.
